(19) United States
(12) Patent Application Publication
(10) Pub. No.: US 2024/0200372 A1
(43) Pub. Date: Jun. 20, 2024

(54) ASSEMBLY FOR OPENING AND/OR CLOSING A VEHICLE DOOR

(71) Applicant: MINEBEA ACCESSSOLUTIONS ITALIA S.P.A., Pianezza (IT)

(72) Inventors: Anthony GUERIN, Pianezza (IT); Massimo FRATTINI, Pianezza (IT); Andrea VIETTI, Pianezza (IT)

(73) Assignee: MINEBEA ACCESSSOLUTIONS ITALIA S.P.A., Pianezza (IT)

(21) Appl. No.: 18/539,384

(22) Filed: Dec. 14, 2023

(30) Foreign Application Priority Data
Dec. 19, 2022 (EP) 22214722.5

(51) Int. Cl. E05B 85/10; E05B 81/76

(52) U.S. Cl. CPC E05B 85/10; E05B 81/76

(57) ABSTRACT

“An assembly for opening and/or closing a vehicle door includes a grip member configured to be attached to an external side of a vehicle door. The grip member includes a base configured to extend from the vehicle door when the grip member is attached to the external side of the vehicle door, and a gripping part extending from the base toward an upper direction when the grip member is attached to the external side of the vehicle door. The assembly further includes an electronic switch subassembly configured to be attached to the grip member and to be activated by a user's touch and send a signal to an electronic latch to open the door. The electronic switch subassembly includes a switch contact area facing downwards when the grip member is attached to the external side of the vehicle door.”

### CROSS-REFERENCE TO RELATED APPLICATIONS

This application claims priority to and the benefit of European Application No. 22214722.5 filed on Dec. 19, 2022. The disclosure of the above application is incorporated herein by reference.

### FIELD

The present disclosure relates to an assembly for opening and/or closing a vehicle door, a vehicle door including the assembly and a method of mounting the assembly on a vehicle door.

### BACKGROUND

The statements in this section merely provide background information related to the present disclosure and may not constitute prior art.

Electronic assemblies for opening and/or closing a vehicle door generally include a handle and electronic element configured to unlock the vehicle door and to activate a latch, such as an electronic latch, to open the vehicle door.

Nowadays, door system are becoming more and more electrical. The handle is more likely to use an electrical signal to release the latch than a mechanical connection. To generate the electrical signal from the handle, different solutions can be used such as switches or sensors. The most common solution used involves a mechanical switch.

It is known, for example, to arrange such a mechanical switch on an external side of the vehicle door, near the window of the vehicle door. Once touched by a user's hand, the mechanical switch activates an electronic latch causing the vehicle door to unlatch and open.

However, there is a risk of opening the door from the inside of the vehicle door when the user is driving. For example, if the user inadvertently puts his hand on the mechanical switch when the window is open.

The present disclosure addresses these and other issues associated with typical assemblies for opening/closing a vehicle door.

### SUMMARY

This section provides a general summary of the disclosure and is not a comprehensive disclosure of its full scope or all of its features.

The present disclosure provides an opening through a switch that is not easily reachable from the inside of the vehicle when the user is driving.

The present disclosure provides an assembly for opening and/or closing a vehicle door. The assembly includes a grip member configured to be attached to an external side of a vehicle door. The grip member includes: a base configured to extend from the vehicle door, for example the external side of the vehicle door, when the grip member is attached to the external side of the vehicle door; and a gripping part extending from the base, and toward an upper direction when the grip member is attached to the external side of the vehicle door. The assembly further includes an electronic switch subassembly configured to be attached to the grip member and configured to be activated by a user's touch so as to send a signal to an electronic latch to open the door. The electronic switch subassembly includes a switch contact area, facing downwards when the grip member is attached to the external side of the vehicle door.

Due to the switch contact area arranged to face downwards when the grip member is attached to the external side of the vehicle door, the switch contact area is not easily reachable from the inside of the vehicle when the user is driving.

The assembly for opening and/or closing a vehicle door can include the following features, considered alone or in any technically possible combination.

The gripping part includes a traction surface configured to allow exertion of a traction on the grip member so as to pull on the vehicle door. The traction surface faces the vehicle door when the grip member is attached to the external side of the vehicle door. The assembly is arranged so that a thumb of user's hand can touch the switch contact area while one or more other fingers of the user's same hand are touching the traction surface at the same time.

The assembly includes a light source subassembly including a light source arranged so that at least part of the light source faces away from the vehicle door when the grip member is attached to the external side of the vehicle door.

The light source subassembly includes a window part that is at least partially transparent, for example transparent, to the light emitted by the light source, the window part arranged on the base and/or on a lower part of the grip member.

The electronic switch subassembly includes at least two switch elements. Each switch element includes one or more switch(es). The switch elements are arranged at different positions with respect to the switch contact area so that a user's touch on the switch contact area activates at least one of the switches.

Each switch element includes a first switch and a second switch, the switch subassembly being activated when at least one of the first switches is activated and at least one of the second switches is activated.

The first switches and the second switches are configured such that the output signal sent by of each of the output signals of the first switches when activated is inverted with respect to the output signal sent by each of the second switches when activated.

The electric switch subassembly includes a first electrical subcircuit connecting the first switches together, and a second electrical subcircuit connecting the second switch elements together, the first electrical subcircuit being distinct from the second electrical subcircuit.

The grip member includes for each switch element, a corresponding contact subcircuit allowing activation of the one or more switch(es) of the switch element by a user's touch on the switch contact area.

The assembly includes a frame configured to cooperate with the switch contact area to define an inner space wherein at least two switch elements are arranged.

The assembly includes a frame configured to cooperate with the switch contact area to define an inner space wherein the printed circuit board assembly is arranged.

The frame is fixed to the grip member and wherein a contact zone between the frame and the grip member is sealed by laser welding to form a waterproof seal.

The assembly includes a fixation element configured to be attached to the vehicle door, wherein an aperture is arranged in the fixation element to allow access to the switch contact area by the user's hand, e.g., the user's thumb.

According to a further aspect, the present disclosure concerns a vehicle door including the assembly for opening and/or closing a vehicle door as previously described, and a belt line from which a window glass can extend.

For example, the grip member is attached to an external side of the vehicle door, at the belt line.

According to a further aspect, the present disclosure concerns a method of mounting the assembly on a vehicle door the method including: assembling the electronic switch subassembly to the grip member; arranging at least a part of the assembled electronic switch subassembly and grip member in the aperture of the fixation element; and attaching the fixation element to the vehicle door.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows an exploded schematic perspective view of an assembly for opening and/or closing a vehicle door according to one form of the present disclosure;

FIG. 2 shows a schematic perspective view of a vehicle door including the assembly of FIG. 1;

FIG. 3 shows a perspective view of the assembly of FIG. 1;

FIG. 4 shows a different perspective view of the assembly of FIG. 1;

FIG. 5 shows a different perspective view of the assembly of FIG. 1;

FIG. 6 shows a bottom view of a printed circuit board of the assembly of FIG. 1;

FIG. 7 shows a top view of the printed circuit board of FIG. 6;

FIG. 8 shows a perspective view of a grip member and an electronic switch subassembly mounted on a fixation element of the assembly of FIG. 1, according to the present disclosure;

FIG. 9 shows an exploded perspective view of the grip member, the electronic switch subassembly and the fixation element of FIG. 8;

FIG. 10 shows a schematic cross-sectional view of an electronic switch subassembly and a light source subassembly of the assembly of FIG. 1, according to present disclosure;

FIG. 11 shows a schematic cross-sectional view of an electronic switch subassembly and a light source subassembly of the assembly of FIG. 1 according to present disclosure;

FIG. 12 shows a perspective view of an electronic switch subassembly and a light source subassembly of the assembly of FIG. 1, schematically illustrating a user's hand according to present disclosure;

FIG. 13 is a perspective view showing a step of a method of mounting the assembly of FIG. 1 on a vehicle door according to a first form, according to the present disclosure;

FIG. 14 is a perspective view showing a step of a method of mounting the assembly of FIG. 1 on the vehicle door according to FIG. 13, according to the present disclosure;

FIG. 15 is a perspective view showing a step of a method of mounting the assembly of FIG. 1 on a vehicle door according to a first variant of the first form, according to the present disclosure;

FIG. 16 is a perspective view showing a step of a method of mounting the assembly of FIG. 1 on a vehicle door according to a second variant of the first form, according to the present disclosure;

FIG. 17 is a side view showing a step of a method of mounting the assembly of FIG. 1 on a vehicle door according to a second form according to the present disclosure;

FIG. 18 is a perspective view showing a step of a method of mounting the assembly of FIG. 1 on a vehicle door according to the second form, according to the present disclosure;

FIG. 19 is a perspective view showing a step of a method of mounting the assembly of FIG. 1 on a vehicle door according to a first variant of the second form, according to the present disclosure; and

FIG. 20 is a perspective view showing a step of a method of mounting the assembly of FIG. 1 on a vehicle door according to a second variant of the second form, according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

### Assembly

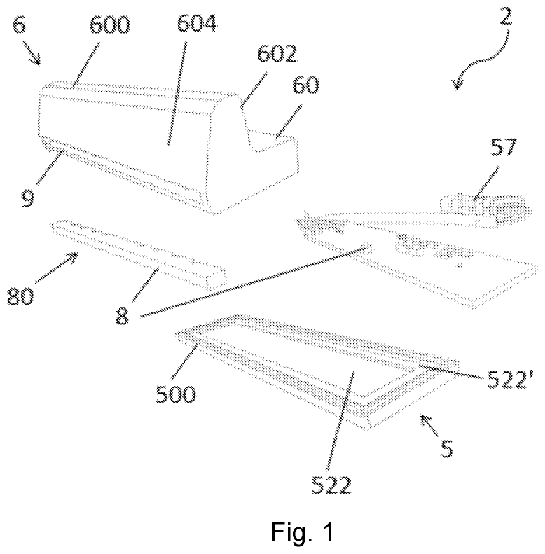

FIG. 1 illustrates an assembly 2 for opening and/or closing a vehicle door according to the present disclosure.

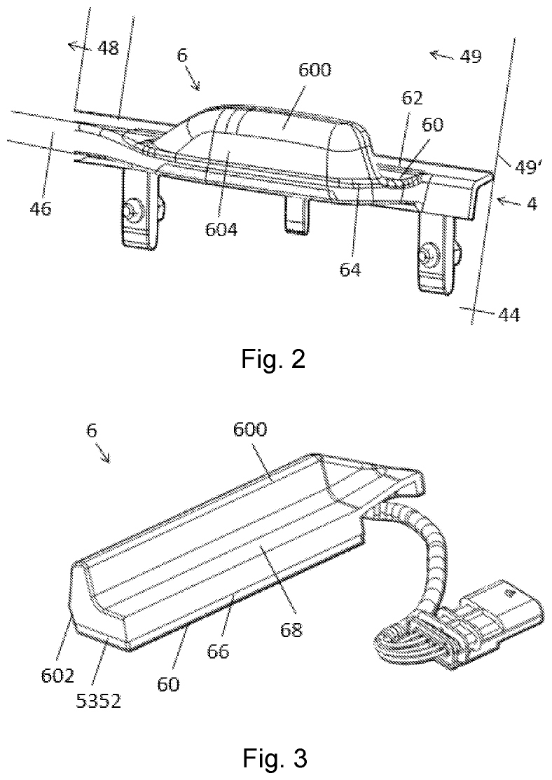

The assembly 2 includes a grip member 6 configured to be attached to a vehicle door 4, for example an external side 44 of the vehicle door 4 (FIG. 2) and an electronic switch subassembly 5 configured to be activated by a user's touch so as to send a signal to an electronic latch (not shown) to open the vehicle door 4. The vehicle door 4 is, for example, a lateral door of the vehicle or the trunk door.

### Grip Member

FIG. 3 illustrates the grip member 6 according to the present disclosure.

The grip member 6 is configured to be arranged at a belt line 46 of the vehicle door 4. A window glass 48, for example, can extend from the belt line 46 (FIG. 2).

The grip member 6 is dimensioned to be graspable by the user's hand. The grip member 6 is dimensioned to allow exertion of a traction on the grip member 6 to pull on the vehicle door 4 to open the vehicle door 4 when the grip member 6 is attached to the vehicle door 4. The grip member 6 is further dimensioned to allow the exertion of a pressure on the grip member 6 to push on the vehicle door 4 to close the vehicle door 4 when the grip member is attached to the vehicle door 4.

The grip member 6 includes a base 60 configured to extend from the vehicle door 4, for example the external side 44 of the vehicle door 4, when the grip member 6 is attached to the vehicle door 4, for example to the external side 44 of the vehicle door 4 as illustrated in FIG. 3.

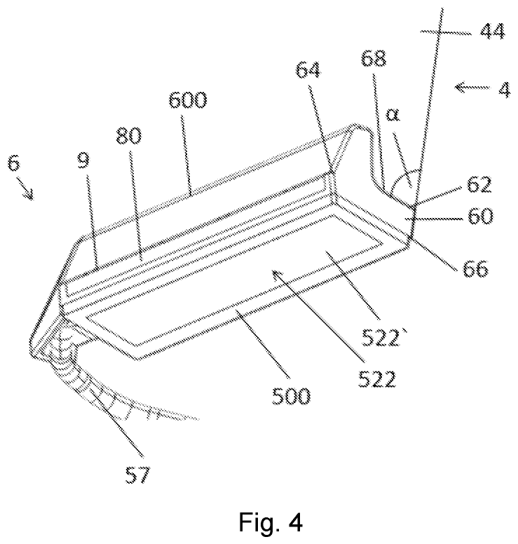

For example, the base 60 can extend at an angle “a” (FIG. 4) that is between 70° and 110° with respect to the external side 44 of the vehicle door 4. For example, in one form the base 60 can extend at an angle “a” of 90° (FIG. 4) with respect to the external side 44 of the vehicle door 4. For example, the base 60 can extend perpendicularly with respect to the external side 44 of the vehicle door.

The grip member 6 includes a gripping part 600 extending from the base 60. The gripping part 600 is intended to be grasped by the user's hand. The gripping part 600 is configured to extend from the base 60 toward an upper direction when the grip member 6 is attached to the external side 44 of the vehicle door 4. For example, the gripping part 600 extends at an angle between 70° and 110° with respect to the base 60 of the grip member 6. For example, the gripping part 600 extends at an angle of 90° with respect to the base 60 of the grip member 6. For example, the gripping part 600 can extend perpendicularly with respect to the base 60 of the grip member 6. For example, the gripping part 600 can extend with respect to the base 60 so that the grip member 6 has a “L-shape”. For example, the grip member 6 is a “L-shape” grip member 6.

The base 60 can include a first edge 62 proximal to the vehicle door 4 when the grip member 6 is attached to the vehicle door 4, and an opposite second edge 64, distal to the vehicle door 4 when the grip member 6 is attached to the vehicle door 4. For example, the gripping part 600 extends from the distal edge 64 of the base 60. This configuration permits to the gripping part 600 to extend away from the vehicle door 4.

For example, the gripping part 600 can include a traction surface 602 configured to allow exerting a traction on the grip member 6 to pull on the vehicle door 4. For example, the traction surface 602 (FIG. 1) is configured to be disposed facing the vehicle door 4 when the grip member 6 is attached to the external side 44 of the vehicle door 4.

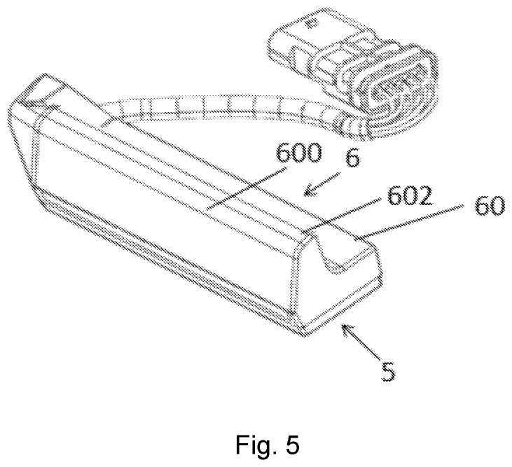

For example, the gripping part 600 can include a pressure surface 604 (FIG. 3) configured to allow exerting a pressure on the grip member 6 to push on the vehicle door (FIG. 5). For example, the pressure surface 604 is arranged opposite to the traction surface 602.

The base 60 and the gripping part 600 can be formed in one piece, for example the base 60 and the gripping part 600 form a single piece.

### Electronic Switch Subassembly

The electronic switch subassembly 5 is configured to be activated by a user's touch to send a signal to an electronic latch (not shown) to open the vehicle door 4.

According to the present disclosure, the electronic switch subassembly 5 is attached to the grip member 6 (FIG. 4). The electric switch subassembly 5 includes a switch contact area 522 (FIG. 3). The switch contact area 522 is configured to be touched by a user's thumb when the grip member is attached to the vehicle door (FIG. 5).

According to the present disclosure, the switch contact area 522 is facing downwards when the grip member 6 is attached to the external side 44 of the vehicle door 4. For example, the switch contact area 522 extends along a surface of the grip member 6 facing downwards when the grip member 6 is attached to the external side 44 of the vehicle door 4 (FIG. 2). For example, the switch contact area 522 extends along a surface 66 of the base 60 and/or a surface of a lower part of the gripping part 60 facing downwards when the grip member 6 is attached to the external side 44 of the vehicle door 4. For example, the switch contact area 522 extends along a first surface 66 of the base 60, opposite to a second surface 68 of the base, the second surface 68 of the base being adjacent to the gripping part 600 (FIG. 4). For example, the switch contact area 522 extends along a first surface 66 of the base 60, opposite to a second surface 68 of the base 60 from which the gripping part extends.

The assembly 2 can be arranged so that, a thumb of the user's hand can touch the switch contact area 522 while one or more other fingers of the user's same hand are touching the traction surface 602 at the same time (FIG. 5).

The assembly 2 is arranged so that, a thumb of user's hand can be in contact with the switch contact area 522 while one or more other fingers of the user's same hand are in contact with the traction surface 602 at the same time. For example, the switch contact area 522 extends perpendicularly with respect to the traction surface 602 (FIG. 1).

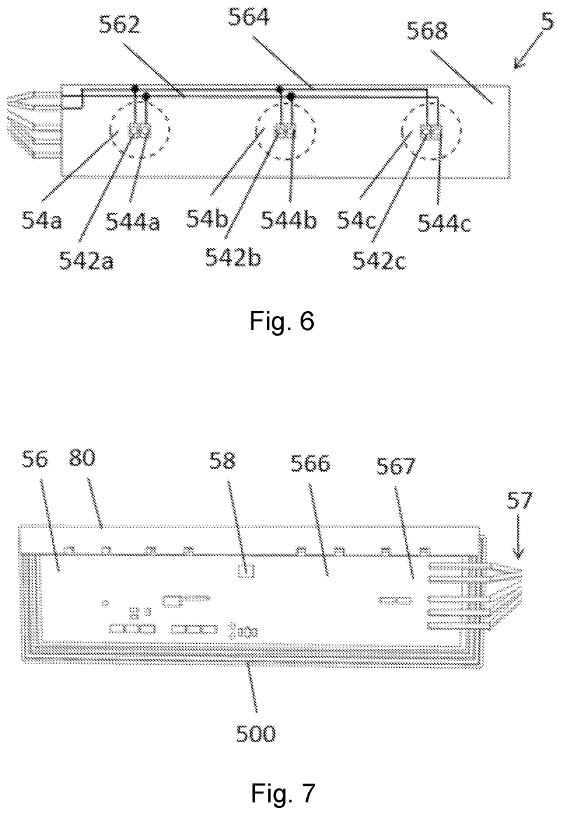

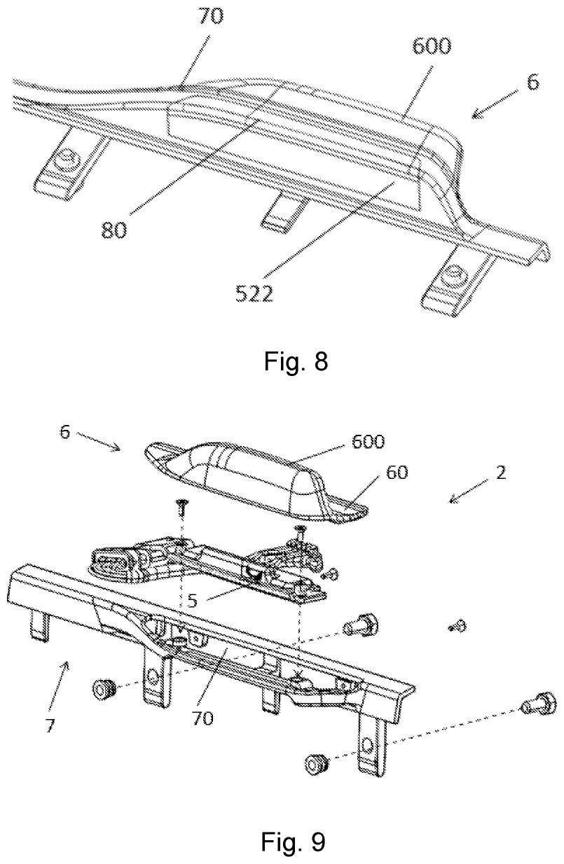

The electronic switch subassembly 5 can include at least two switch elements 54a, 54b, 54c (FIG. 6).

The at least two switch elements 54a, 54b, 54c are facing downwards when the grip member 6 is attached to the external side 44 of the vehicle door 4.

Each switch element 54a, 54b, 54c includes one or more switch(es) 542a, 542b, 542c, 544a, 544b, 544c. The switch elements 54a, 54b, 54c are arranged at different positions with respect to the switch contact area 522 so that a user's touch on the switch contact area 522 activates at least one of the switches 542a, 542b, 542c, 544a, 544b, 544c.

For example, the at least three switch elements 54a, 54b, 54c can be arranged at different positions, with respect to the lower part of the gripping part 6 and/or the base 60, so that a user's touch on the switch contact area 522 activates at least one of the at least three switches 542a, 542b, 542c, 544a, 544b, 544c.

For example, the at least three switch elements 54a, 54b, 54c can be arranged at different positions with respect to the first surface 66 of the base 60 of the grip member 6, so that a user's touch on the switch contact area 522 activates at least one of the at least three switches 542a, 542b, 542c, 544a, 544b, 544c.

Due to the use of several switch elements 54a, 54b, 54c arranged at different positions with respect to the switch contact area 522, the user is likely to activate the switch by touch without having to probe several areas of the door.

The switch subassembly 5 can include at least three such switch elements 54a, 54b, 54c, for instance the first switch element 54a, the second switch element 54b and a third switch element 54c. Each switch element can thus include one or more switch(es) 542a, 542b, 542c, 544a, 544b, 544c. The at least three switch elements 54a, 54b, 54c can be arranged at different positions, with respect to the contact surface area, so that a user's touch on the switch contact area 522 activates at least one of the at least three switches 542a, 542b, 542c, 544a, 544b, 544c.

Due to the use of three switch elements 54a, 54b, 54c arranged at different positions with respect to the switch contact area 522, the user is even more likely to activate the switch by touch without having to probe several areas of the door.

Having the three switch elements 54a, 54b, 54c as located provides that activation is obtained upon touching the switch contact area 522.

The switch subassembly 5 is, for example, activated when at least two of the switches 542a, 542b, 542c, 544a, 544b, 544c are activated to reduce the risks of an incorrect activation.

Each switch element 54a, 54b, 54c includes a first switch 542a, 542b, 542c and a second switch 544a, 544b, 544c. The switch subassembly 5 is activated when, and in some forms, only when, at least one of the first switches 542a, 542b, 542c is activated and at least one of the second switches 544a, 544b, 544c is activated. This allows for increased reliability of the activation in that it limits unwanted activations or incorrect activations. For instance, when one switch element 54a, 54b, 54c is activated by mistake or when one of the first switches 542a, 542b, 542c or the related circuit is damaged and activates by mistake while the second switches 544a, 544b, 544c and related circuit are functional the switch assembly 5 will not activate unless at least one of the second switches 544a, 544b, 544c is activated as well. Similarly, if one of the second switches 544a, 544b, 544c or related circuit is damaged and activates by mistake while the first switches 542a, 542b, 542c and related circuit are functional the switch assembly 5 will not activate unless at least one of the first switches 542a, 542b, 542c is activated.

The first switch element 54a includes the first first switch 542a and the first second switch 544a. The second switch element 54b includes the second first switch 542b and the second second switch 544b. For example, the third switch element 54c includes the third first switch 542c and the third second switch 544c. For example, activation can result from the first first switch 542a and the first second switch 544a being activated, but activation can also result from the first first switch 542a and the third second switch 544c being activated.

The first switches 542a, 542b, 542c and the second switches 544a, 544b, 544c can be configured such that the output signal sent by each of the output signals of the first switches 542a, 542b, 542c when activated is inverted with respect to the output signal sent by each of the second switches 544a, 544b, 544c when activated. The first switches 542a, 542b, 542c and the second switches 544a, 544b, 544c can be configured such that the output signal sent by each of the output signals of the first switches 542a, 542b, 542c when not activated is inverted with respect to the output signal sent by each of the second switches 544a, 544b, 544c when not activated. Therefore, the output signals of each of the first switches 542a, 542b, 542c are inverted to the output signals of the second switches 544a, 544b, 544c. This further reduces the risks of false activation of the subassembly as two different output signals are used.

For example, each of the first switches 542a, 542b, 542c sends an output signal, indicating an open signal by default, the corresponding circuit part being open, and only if the output signal indicates a closed state, the corresponding circuit part being closed, by instance so as to let the current pass or so as to form a short-circuit, the same first switch 542a, 542b, 542c is activated. For example, each of the second switches 544a, 544b, 544c sends an output signal, indicating a closed state by default, the corresponding circuit part being closed by default, by instance so as to let the current pass or so as to form a short-circuit, and only if the output signal indicates an open state, the corresponding circuit part being open, the same second switch 544a, 544b, 544c is activated.

The first switches 542a, 542b, 542c can, for example, be break contact switch(es) and/or a make contact switch(es). For example, each of the first switches 542a, 542b, 542c can be a break contact switch, or each of the first switches 542a, 542b, 542c can be a make contact switch(es). For example, each of the second switches 544a, 544b, 544c can be a break contact switch, or each of the second switches 544a, 544b, 544c can be a make contact switch. For example, each of the first switches 542a, 542b, 542c can be a break contact switch, and each of the second switches 544a, 544b, 544c can be a make contact switch. For example, each of the first switches 542a, 542b, 542c can be a make contact switch, and each of the second switches 544a, 544b, 544c can be a break contact switch.

As illustrated in FIG. 6, the electronic switch subassembly 5 includes a first electrical subcircuit 562 connecting the first switches 542a, 542b, 542c together. The electronic switch subassembly 5 includes a second electrical subcircuit 564 connecting the second switches 544a, 544b, 544c together. The first electrical subcircuit 562 being distinct from the second electrical subcircuit 564 to allow for further reduction of the risks of false activation of the subassembly by strictly separating the functioning of the first switches and of the second switches.

For instance, the first electrical subcircuit 562 and second electrical subcircuit 564 are not electrically connected in the subassembly 5.

The switch subassembly 5 can include exactly the three switch elements 54a, 54b, 54c, each including the one or more switch(es) 542a, 542b, 542c, 544a, 544b, 544c. The exactly three switch elements 54a, 54b, 54c, are arranged at different positions with respect to the switch contact area 522 so that a user's touch on the switch contact area 522 activates at least one of the switches 54a, 54b, 54c. The use of three switch elements 54a, 54b, 54c, improves the switch contact area 522, which has a size dimensioned with respect to a human's hand, to be fully sensitive while limiting the number of components, and thus simplifying the fabrication and associated costs.

The at least two switch elements 54a, 54b, 54c can be activated by a user's touch on the switch contact area 522.

### Printed Circuit Board Subassembly

The electronic switch subassembly 5 includes a printed circuit board subassembly 56. The printed circuit board subassembly 56 includes the at least two switch elements (FIG. 6), for example the at least three switch elements 54a, 54b, 54c. The printed circuit board subassembly 56 includes the first electrical subcircuit 562 and the second electrical subcircuit 564 (FIG. 6).

The printed circuit board subassembly 56 includes a printed circuit board 566. The printed circuit board 566 includes the first electrical subcircuit 562 and the second electrical subcircuit 564, for instance the first electrical subcircuit 562 and the second electrical subcircuit 564 forming parts of the printed circuit(s) of the printed circuit board 566. The printed circuit board 566 presents the at least two switch elements, for example the at least three switch elements 54a, 54b, 54c. The at least three switch elements 54a, 54b, 54c are electrically connected to the printed circuit(s) of the printed circuit board 566, for instance by welding.

The printed circuit board subassembly 56, for instance the printed circuit board 566, includes an upper face 567 and a lower face 568. The upper face 567 and the lower face 568 are opposite faces. The lower face 568 faces the switch contact area 522. The lower face 568 can present the first electrical subcircuit 562 and the second electrical subcircuit 564 at the surface. The lower face 568 can present the at least two switch elements, for example the at least three switch elements 54a, 54b, 54c.

For example, the lower face 568 of the printed circuit board subassembly 56 is facing downwards when the grip member 6 is attached to the vehicle door 4, and the upper face 567 of the printed circuit board subassembly 56 is facing upwards when the grip member 6 is attached to the vehicle door 4.

### Grip Member Corresponding Contact Subcircuit

The switch elements 54a, 54b, 54c can be activated mechanically.

For example, the at least two switch elements 54a, 54b, 54c can be activated by a user's touch on the switch contact area 522. Alternatively, the grip member 6 can include, for each switch element 54a, 54b, 54c, a corresponding contact subcircuit allowing activation of the one or more switch(es) 542a, 542b, 542c, 544a, 544b, 544c of the switch element 54a, 54b, 54c by a user's touch on the switch contact area 522, for instance on a corresponding part of the switch contact area 522.

The contact subcircuits can extend for example on a surface of the grip member 6 facing downwards when the grip member 6 is attached to the vehicle door 4. For example, the contact subcircuits can extend on the first surface 66 of the base 60 of the grip member 6.

For example, the grip member 6 includes, for the first switch element 54a, a corresponding first contact subcircuit allowing activation of the first first switch 542a and/or of the first second switch 544a by a user's touch on the switch contact area 522. For example, the grip member 6 includes, for the second switch element 54b, a corresponding second contact subcircuit allowing activation of the second first switch 542b and/or of the second second switch 544b by a user's touch on the switch contact area 522. For example, the grip member 6 includes, for the third switch element 54c, a corresponding third contact subcircuit allowing activation of the third first switch 542c and/or of the third second switch 544c by a user's touch on the switch contact area 522.

The switch contact area 522 is for instance overmolded, or obtained by overmolding, for example over the grip member 6, for example over the edges of the surface of the base 60 facing downwards when the grip member 6 is attached to the vehicle door 4. This allows for a tight connection between the grip member 6 and the switch contact area 522.

The grip member 52 or the switch contact area 522 can include or be made of elastic material(s), for example rubber.

For example, the switch contact area 522 includes a membrane 522′, for example made of elastic material (s), for example rubber.

### Light Source Subassembly

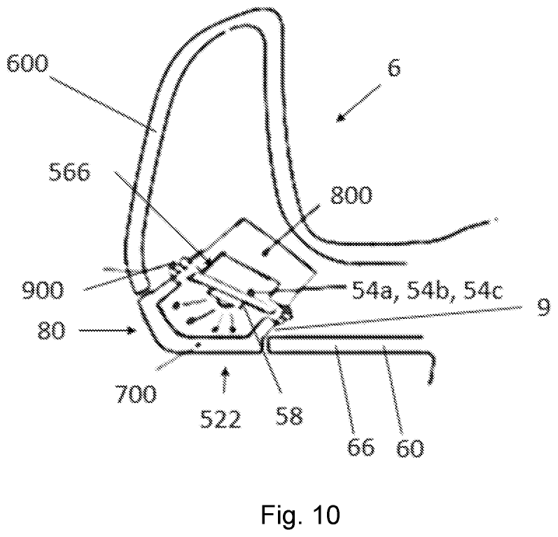

The assembly 2 can include a light source subassembly 8 including a light source 58 arranged so that at least part of the light source 58 faces away from the vehicle door 4 when the grip member 6 is attached to the external side 44 of the vehicle door 4 (FIG. 10). For example, the light source 58 is arranged so that the emitted light illuminates a path to be followed by the user's thumb to reach the switch contact area 522.

The light source 58 is, for example, located upstream of the switch contact area 522 with respect to vehicle door 4. For example, the light source 58 is arranged on the printed circuit board 566 of the electronic switch subassembly 5. For example, the light source 58 is arranged on the upper face 567 of the printed circuit board 566.

For example, the printed circuit board 566 presents the first electrical subcircuit 562 and the second electrical subcircuit 564 at its surface, and/or a light source 58 at its surface.

For example, the light source 58 can include or be one or several light-emitting diode(s). The light source subassembly includes a window part 80 that is at least partially transparent, for example transparent, to the light emitted by the light source 58. The window part 80 is, for example, located upstream the switch contact area 522 with respect to vehicle door 4. For example, the window part 80 is arranged on the base 60 and/or on a lower part of the grip member 6. For example, the window part 80 is arranged at an intersection area between the base 60 and the gripping part 600.

According to a first form, the grip member 6 can include an aperture 9 (FIG. 1) configured to receive at least a part of the window part 80. For example, the aperture 9 is arranged on the base 60 and/or on a lower part of the grip member 6. For example, the window part 80 can be received in the aperture 9 (FIG. 4) and fixed to the grip member 6 via clipping elements.

According to a form of the present disclosure, the electronic switch subassembly 5 and the light source subassembly 8 are combined. For example, the switch contact area 522 and the window part 80 form a unique element 700 as illustrated in FIG. 10.

The unique element 700 extends for example along a surface 66 of the base 60 and a surface of the lower part of the gripping part 600 facing downwards when the grip member 6 is attached to the external side 44 of the vehicle door 4 and is at least partially transparent, for example transparent, to the light source 58.

The grip member 6 can include an aperture 9 configured to receive at least a part of the unique element 700. For example, the aperture 9 is arranged on the base 60 and on a lower part of the grip member 6. For example, the unique element 700 can be received in the aperture 9.

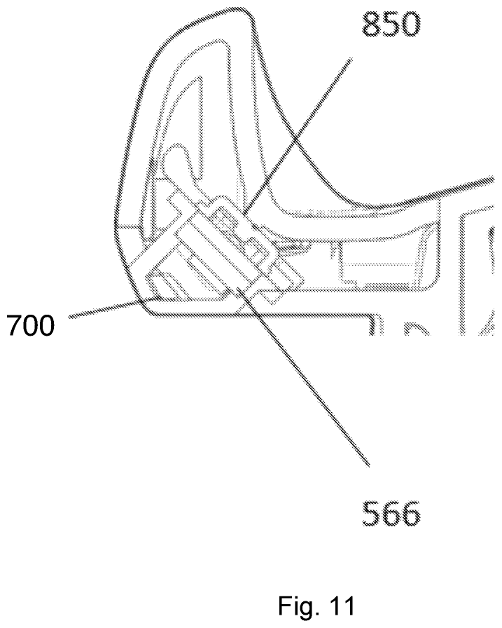

The unique element 700 forming the switch contact area 522 and the window part 80 can be sealed to an inner casing 800 that includes an abutment element 850 (FIG. 11). The unique element 700 and the inner casing 800 form a housing receiving the printed circuit board 566. For example, the printed circuit board 566 can be, fixed to the unique element 700. According to this form, the at least two switch elements 54a, 54b, 54c are facing upward when the grip member 6 is attached to the external side 44 of the vehicle door 4. According to this form, the light source 58 is arranged on the lower face 568 of the printed circuit board 566 and the upper face 567 can present the at least two switch element 54a, 54b, 54c.

A contact zone between the unique element 700 and the inner casing 800 is sealed, by a sealing element 900 configured to allow a displacement of the unique element 700 with respect to the inner casing 800. For example, the sealing element 900 includes a rubber gasket.

The displacement of the unique element 700 is intended to displace the printed circuit board 566 so that the at least two switch elements 54a, 54b, 54c come into contact with the abutment element 850 of the inner casing 800 so as to be activated.

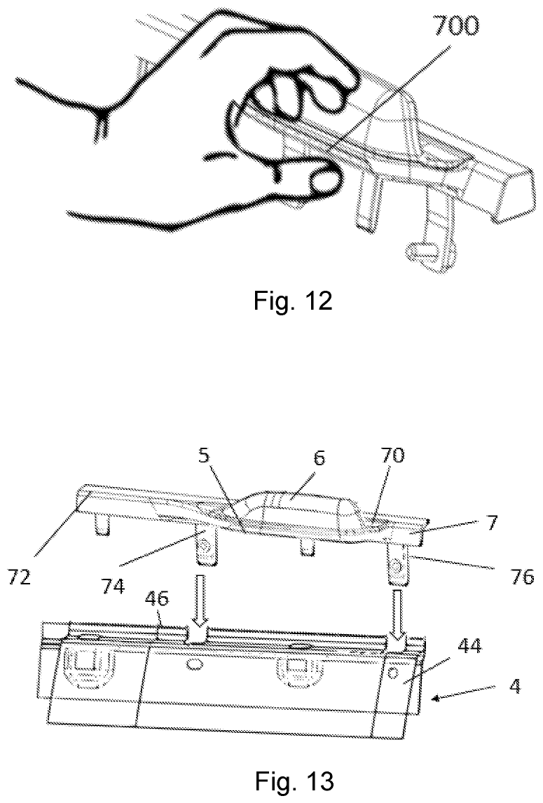

The displacement of the unique element 700 can be realized by applying pressure, for example by pushing on the unique element 700 via a user's thumb (FIG. 12).

### Frame

The electronic switch subassembly 5 can include a frame 500. The frame 500 is configured to attach the switch contact area 522 to the grip member 6. For example, the frame 500 can be fixed to the membrane of the switch contact area 522. For example, the frame 500 can be fixed to a surface of the membrane 522′ facing downwards when the grip member 6 is attached to the vehicle door 4 (FIG. 4). For example, the frame 500 can be fixed to a surface of the membrane 522′ facing upwards when the grip member 6 is attached to the vehicle door 4 (FIG. 9).

For example, the switch contact area 522 is, for instance, overmolded, or obtained by overmolding, over the frame 500 to be surrounded by peripheral walls of the frame 500.

The frame 500 can be a rigid frame 500. The frame 500 and the switch contact area 522, for example the membrane 522′ of the switch contact area 522, are arrange to form an inner space dimensioned to receive the printed circuit board assembly 56.

When the electronic switch subassembly 5 is attached to the grip member 6, the printed circuit board assembly 56 is arranged between the switch contact area 522 and the grip member 6.

The printed circuit board subassembly 56 includes the at least two switches and is arranged between the switch contact area 522 and the grip member 6.

The frame 500 can be configured to be fixed to the grip member 6. For example, the frame 500 is configured to be fixed to a surface of the grip member 6 facing downwards when the grip member 6 is attached to the vehicle door 4. For example, the frame 500 is configured to be fixed to a lower part of the gripping part 600 and/or the base 60 of the grip member 6 when the grip member 6 is attached to the vehicle door 4. For example, the frame 500 is configured to be fixed to a surface of the lower part of the gripping part 600 and/or a surface of the base 60 of the grip member 6 facing downwards when the grip member 6 is attached to the vehicle door 4. For example, the frame 500 is configured to be fixed to the first surface 66 of the base 60 of the grip member 6.

A contact zone 5352 between the frame 500 and the grip member 6 (FIG. 3) is sealed, for example by laser welding, to form a waterproof seal. The seal allows for a protection of the printed circuit board subassembly 56.

### Electrical Connection Element

The electronic switch subassembly 5 can include electrical connection element 57 for electrically connecting the printed circuit board assembly 56 to the electrical latch.

The electrical connection element 57 include one or several electrical wire(s), for example a cable surrounding the wire(s). The electrical wire(s) are provided with connections at both ends.

### Fixation Element

The assembly can include a fixation element 7 (FIG. 9) configured to be attached to the vehicle door 4. For example, the fixation element 7 is configured to be attached to an inner side of the vehicle door 4.

The fixation element 7 can include an aperture 70 arranged in the fixation element 7 so as to allow access to the switch contact area 522 by the user's hand, e.g., the user's thumb.

For example, the aperture 70 opens to the external side 44 of the vehicle door 4 when the fixation element 7 is attached to the inner side of the vehicle door 4. For example, the aperture 70 is arrange to receive at least a part of the window part 80 of the light source subassembly 8.

### Vehicle Door

A vehicle door 4 is described. The vehicle door 4 includes the assembly 2 for opening and/or closing a vehicle door 4 hereabove and a belt line 46 from which a window glass can extend. The beltline 46 is a line representing the bottom edge of a vehicle's glass panels.

The grip member 6, to which the electronic switch subassembly 5 is attached, is, for example, attached to an external side 44 of the vehicle door 4 at the belt line 46.

The grip member 6, to which the electronic switch subassembly 5 is attached, is, for example, arranged at the belt line 46 between a window glass 48 and an end portion 49 of the vehicle door 4.

As used herein, the term “end portion of the vehicle door” means a portion including an edge of the vehicle door, a free end 49′ of the vehicle door.

### Method for Opening

A method for opening a vehicle door 4 via the assembly 2 is described. The method includes the activation of the at least one electronic switch subassembly 5 by a user's touch to send a signal to an electronic latch to open the door 4. The activation of the at least one electronic switch subassembly 5 includes, in response to a user's touch on the switch contact area 522, a step of activation of at least one of the switches 542a, 542b, 542c, 544a, 544b, 544c, for instance as described hereabove.

The signal to an electronic latch to open the door 4 can also include a signal to unlock the door 4.

### Method for Obtaining a Subassembly

A method for obtaining the subassembly 5 is described. The method includes assembling the frame 500, the switch contact area 522 and the printed circuit board assembly 56.

### Method for Mounting

A method for mounting the assembly on a vehicle door is described. The method includes assembling the electronic switch subassembly 5 to the grip member 6

For example, the method can include the sealing of the contact zone 5352 between the frame 500 and the grip member 6, for example by laser welding, to form a waterproof seal.

The method includes arranging at least a part of the assembled electronic switch subassembly 522 and grip member 6 in the aperture 70 of the fixation element 7.

The method includes attaching the fixation element 7 to the vehicle door 4.

According to a first form of the present disclosure illustrated in FIGS. 9 and 13 to 16, the method includes a first step of assembling the electronic switch subassembly 5 to the grip member 6. The method can include the sealing of the contact zone 5352 between the frame 500 and the grip member 6, for example by laser welding, to form a waterproof seal.

The method includes a second step of arranging at least a part of the assembled electronic switch subassembly 5 and grip member 6 in the aperture 70 of the fixation element 7. The electronic switch subassembly 5 and grip member 6 can be fixed to the fixation element 7, for example, via fixation elements, such as screws, or via rigid clips or by gluing or by welding.

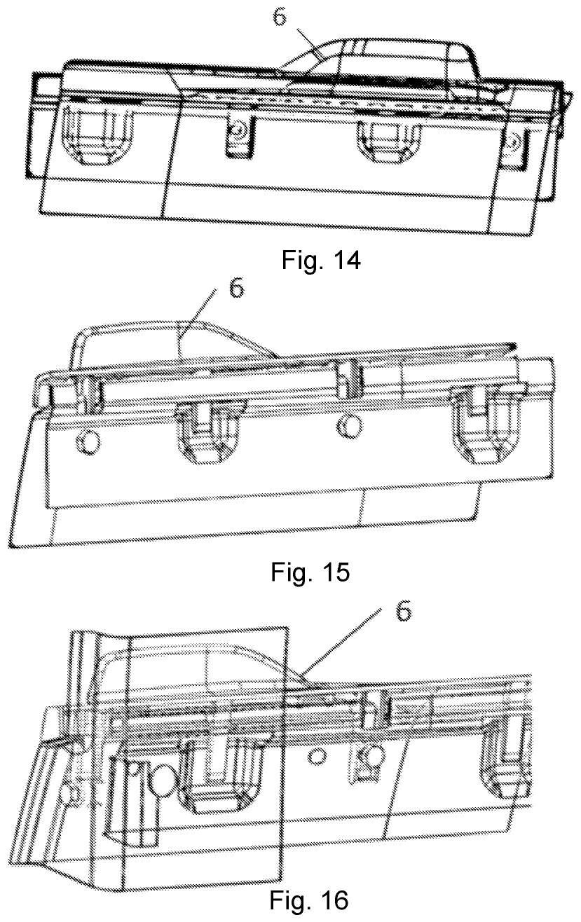

The method includes a third step of attaching the fixation element 7 to the vehicle door 4, for example, from an external side 44 of the vehicle door 4 (FIGS. 13, and 14). For example, a part of the fixation element 7 is attached to an inner side of the vehicle door 4. For example, the part is at least one leg 74, 76, for example two legs 74, 76 extending from a base 72 of the fixation element 7. For example, the method includes a step of arranging the at least one leg 74, 76 of the fixation element 7, from an external side 44 of the vehicle door 4, to an inner side of the vehicle door 4, for example through holes arranged in a door panel of the vehicle door 4. The at least one leg 74, 76 can be attached to the inner side of the vehicle door 4, for example, via fixation elements such as screws. For example, the at least one leg 74, 76 is attached to the inner side of a vehicle door 4 via a screw, screwed along a direction perpendicular with respect to the vehicle door 4.

According to a variant, the method includes a step wherein each of the two legs 74, 76 is attached to the inner side of a vehicle door 4 via a screw, screwed along a direction perpendicular with respect to the vehicle door 4 (FIG. 15).

According to a variant, the method includes a step wherein one leg 74 is attached to the inner side of a vehicle door 4 via a screw, screwed along a direction perpendicular with respect to the vehicle door 4 and the other leg 76 is attached to the inner side of a vehicle door 4 via a screw, screwed along a direction parallel with respect to the vehicle door 4 (FIG. 16).

The second step can be performed after the first step, and the third step can be performed after the second step.

According to a variant, the third step can be performed after the first step and before the second step.

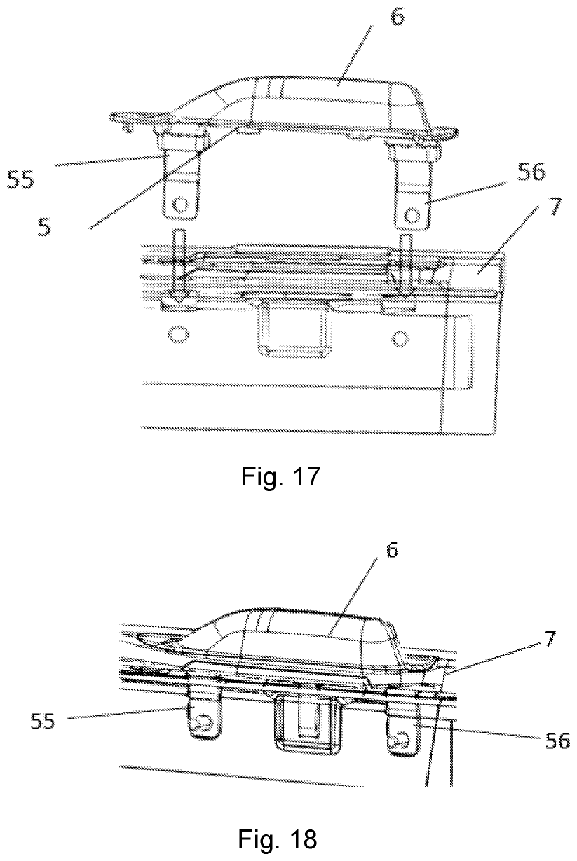

According to a second form of the method of mounting, illustrated in FIGS. 17 to 20, the method includes a first step of attaching or assembling the fixation element 7 to the vehicle door 4. For example, the fixation element 7 is attached to an inner side of the vehicle door 4. The fixation element 7 can be attached to the vehicle door 4. via fixation elements, such as screws.

The method includes a second step of assembling the electronic switch subassembly 5 to the grip member 6.

The method includes the sealing of the contact zone 5352 between the frame 500 and the grip member 6, for example by laser welding, to form a waterproof seal.

The method includes a third step of arranging at least a part of the electronic switch subassembly 5 and grip member 6 in the aperture 70 of the fixation element 7, attached to the vehicle door 4.

The method includes a step of arranging at least one leg 55, 56, for example two legs 55, 56, extending from the electronic switch subassembly 5 and/or the grip member 6, from an external side 44 of the vehicle door 4 to an inner side of the vehicle door 4, for example through holes arranged in the fixation element 70 (FIGS. 17 and 18). The at least one legs 55, 56 can be attached to the inner side of the vehicle door 4, for example, via fixation elements, such as screws.

The method includes a step wherein at least one leg 55, 56 is attached to the inner side of a vehicle door 4 via a screw, screwed along a direction perpendicular with respect to the vehicle door 4.

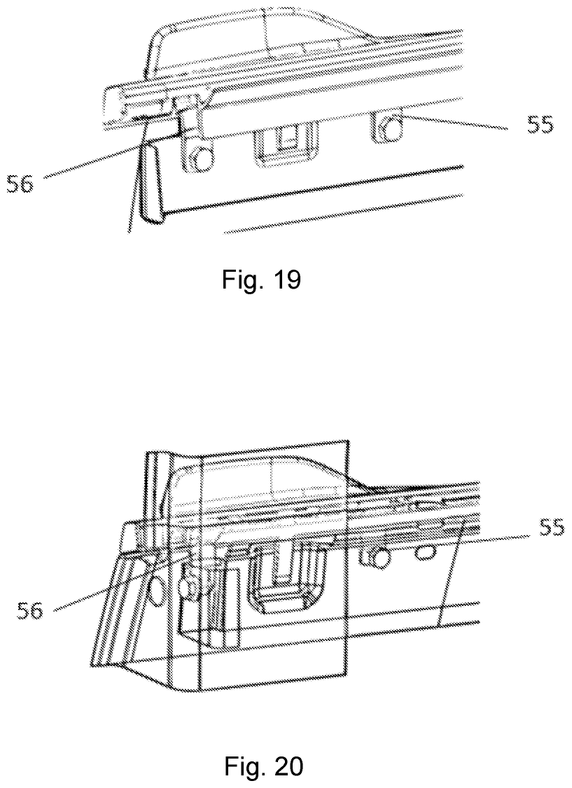

According to a variant illustrated in FIG. 19, the method includes a step wherein each of the two legs 55, 56 is attached to the inner side of a vehicle door 4 via a screw, screwed along a direction perpendicular with respect to the vehicle door 4.

According to a variant illustrated in FIG. 20, the method includes a step wherein one leg 55 is attached to the inner side of a vehicle door 4 via a screw, screwed along a direction perpendicular with respect to the vehicle door 4 and the other leg 56 is attached to the inner side of a vehicle door 4 via a screw, screwed along a direction parallel with respect to the vehicle door 4.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

1-14. (canceled)

1. An assembly for opening, closing, or opening and closing a vehicle door, the assembly comprising:
a grip member configured to be attached to an external side of a vehicle door, the grip member comprising:
a base configured to extend from the vehicle door when the grip member is attached to the external side of the vehicle door; and
a gripping part extending from the base and toward an upper direction when the grip member is attached to the external side of the vehicle door; and
an electronic switch subassembly attached to the grip member and configured to be activated by a user's touch to send a signal to an electronic latch to open the door, the electronic switch subassembly comprising a switch contact area facing downwards when the grip member is attached to the external side of the vehicle door.

2. The assembly according to claim 1, wherein the gripping part comprises a traction surface configured to allow exertion of a traction on the grip member to pull on the vehicle door, the traction surface facing the vehicle door when the grip member is attached to the external side of the vehicle door, and wherein the assembly is arranged so that a thumb of a user's hand can touch the switch contact area while one or more other fingers of the user's hand are touching the traction surface simultaneously.

3. The assembly according to claim 1, further comprising a light source subassembly comprising a light source arranged so that at least part of the light source faces away from the vehicle door when the grip member is attached to the external side of the vehicle door.

4. The assembly according to claim 3, wherein the light source subassembly comprises a window part that is at least partially transparent to the light emitted by the light source, the window part being arranged on at least one of the base and a lower part of the grip member.

5. The assembly according to claim 1, wherein the electronic switch subassembly comprises at least two switch elements, each switch element comprising one or more switch(es), the at least two switch elements being arranged at different positions with respect to the switch contact area so that a user's touch on the switch contact area activates at least one of the switches.

6. The assembly according to claim 5, wherein each of the at least two switch elements comprises a first switch and a second switch, the switch subassembly configured to be activated when:
at least one of the first switches is activated; and
at least one of the second switches is activated.

7. The assembly according to claim 6, wherein the electronic switch subassembly comprises a first electrical subcircuit connecting the first switches together, and a second electrical subcircuit connecting the second switches together, the first electrical subcircuit being distinct from the second electrical subcircuit.

8. The assembly according to claim 7 comprising a frame configured to cooperate with the switch contact area so as to define an inner space wherein the at least two switch elements are arranged.

9. The assembly according to claim 8 wherein the frame is fixed to the grip member and wherein a contact zone between the frame and the grip member is sealed by laser welding to form a waterproof seal.

10. The assembly according to claim 6, wherein the first switches and the second switches are configured such that a first output signal sent by each of the first switches when activated is inverted with respect to a second output signal sent by each of the second switches when activated.

11. The assembly according to claim 10, wherein the electronic switch subassembly comprises a first electrical subcircuit connecting the first switches together, and a second electrical subcircuit connecting the second switches together, the first electrical subcircuit being distinct from the second electrical subcircuit.

12. The assembly according to claim 11 comprising a frame configured to cooperate with the switch contact area to define an inner space wherein the at least two switch elements are arranged.

13. The assembly according to claim 12 wherein the frame is fixed to the grip member and wherein a contact zone between the frame and the grip member is sealed by laser welding to form a waterproof seal.

14. The assembly according to claim 1, further comprising a fixation element configured to be attached to the vehicle door, wherein an aperture is arranged in the fixation element, the aperture allowing access to the switch contact area by a thumb of a user's hand.

15. A method for mounting an assembly on a vehicle door according to claim 14, the method comprising:
assembling the electronic switch subassembly to the grip member;
arranging at least a part of the assembled electronic switch subassembly and grip member in the aperture of the fixation element; and
attaching the fixation element to the vehicle door.

16. A vehicle door comprising:
the assembly for opening, closing, or opening and closing a vehicle door according to claim 1;
a belt line; and
a window glass extending from the belt line.

17. The vehicle door according to claim 16, wherein the grip member is attached to the external side of the vehicle door, at the belt line.
